(19) United States
(12) Patent Application Publication
(10) Pub. No.: US 2011/0033573 A1
(43) Pub. Date: Feb. 10, 2011

(54) Alternative lobster and crab bait and method of manufacture

(76) Inventor: Shane Evans Renshaw, Marshfield, ME (US)

Correspondence Address: Shane Renshaw, 220 Ridge Road, Marshfield, ME, 04654, US

(21) Appl. No.: 12/462,567

(22) Filed: Aug. 4, 2009

(51) Int. Cl. A01K 97/04; A01K 69/00

(52) U.S. Cl. 426/1

(57) ABSTRACT

Disclosed is a bait that serves as an alternative to the traditional use of whole or cut fish in the marine lobster and crab fishery. The bait is comprised of ground fish, fish oil, and a unique binder in the form of a wax like substance consisting of 100% natural palm oil or palm kernel oil.

### CROSS REFERENCE TO RELATED APPLICATIONS

Not Applicable.

### STATEMENT REGARDING FEDERALLY SPONSORED RESEARCH AND DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The field of the invention relates to a bait utilized in the marine crustacean fishery.

The traditional marine trap fishery for lobsters and crustaceans relies on the use of whole or cut fish placed in a bait bag secured in a trap. Such fish used as bait breaks down rather quickly, often in as little as 2-3 days. Additionally, supply issues exist that can place economic hardships on fishermen who utilize whole or cut fish.

Various attempts have been made to provide an alternative bait for use in the crustacean fishery. Participants and regulators involved with the marine lobster and crab fishery agree that any alternative bait should last as long or longer than traditional whole or cut fish, be as effective at attracting crustaceans as whole or cut fish and not be made of any materials that could cause concern to consumers or fishermen.

Currently there are four alternative baits being marketed to the lobster or crab fishery. Baits made from the hide of cattle have been widely used and have shown some ability to attract lobsters while remaining intact in the bait bag longer than whole or cut fish. The problem with the hide baits is the hairs from the hides have shown up inside lobsters causing concerns to consumers, which has necessitated a ban on all hide bait that has not had the hair removed from through mechanical or chemical means.

A second product in the form of a hockey puck made by the company Popeye's has been shown to last longer in the bait bag than whole or cut fish but with questionable success at attracting lobsters. The main concern with this bait is its use of polyvinyl chloride (plastic) as its main binding agent.

A third bait manufactured by the Betta Bait Company utilizes gelatin as a binding agent and fish meal or fish oil as an attractant. The use of gelatin, a substance often derived from livestock processing, may be of some concern to environmentally conscious fishermen.

A fourth bait has recently been proposed consisting of fishmeal, alginate or carrageenan, calcium compounds and fish hydrolyzate. The acceptance of this bait by fishermen has yet to be assessed.

### BRIEF SUMMARY OF THE INVENTION

This invention details the use of a unique binder in the form of a palm “wax” consisting of 100% all natural palm oil and or palm kernel oil to render a mixture of freshly ground fish and fish oil in such a form as to attract marine crustaceans while lasting in the marine environment longer than traditional use of whole or cut fish.

Further is included the method of manufacture of said bait comprising the mixing of said palm oil and/or palm kernel oil with freshly ground menhaden and/or herring and menhaden and/or herring oil and the application of this final mixture to molds of varying sizes and shapes to fit in the bait bag of the traditional marine crustacean fishery.

### BRIEF DESCRIPTION OF THE SEVERAL VIEWS OF THE DRAWING

Not Applicable

### DETAILED DESCRIPTION

This invention is an all-natural lobster and crab bait derived from marine and plant based materials. The bait is found to hold up longer in traps than the traditional whole or cut fish and has been found to be as effective as whole or cut fish in attracting lobsters and crabs.

The bait utilizes fresh ground marine fish, which is believed by fishermen to be more effective in attracting lobsters than decomposing fish. Additionally, fish oil in the form of menhaden and/or herring oil provides an additional source of attractant.

The bait not only works to attract lobsters and crabs to the trap, but due to its durability, provides an incentive for the lobster to stay in the trap which increases the fishermen's catch. Traditional whole or cut fish degrades quickly lasting in the trap as little as two to three days.

The bait utilizes an all natural plant based binder in the form of palm oil and/or palm kernel oil; oils that are solid at room temperature. The binder is added in sufficient quantity to provide a bait with such a consistency to last in the trap approximately fourteen days.

The bait is manufactured by adding a mixture of melted palm and/or palm kernel oil and fish oil to ground fish. The resulting combination is mixed until it achieves a uniform consistency and then is placed into various shaped molds to harden. After hardening, the bait is cut into various shaped pieces to fit into the bait bags.

### EXPERIMENTAL RESULTS

Fishermen using whole or cut herring as a control in the town of Cutler, Machiasport and Pembroke utilizing the bait in question achieved catch rates consistent with traps with whole or cut fish. In certain trials, it was reported the bait in question outperformed whole or cut fish in attracting lobsters and crabs. The bait was found to last longer in traps than whole or cut fish, approximately fourteen days on average.

It is thus seen that the bait concerned in this invention may be provided as a suitable lobster and crab bait in the commercial marine crustacean fishery.

1) A crustacean bait comprised of ground herring or menhaden, menhaden or herring oil or a combination thereof and 100% natural palm oil and or palm kernel oil, said bait being of such consistency to achieve a longer presence in the crustacean trap than is achieved with traditional use of whole or cut fish.

2) The bait of claim 1 is a bait designed to attract lobsters and crabs.

3) The bait of claim 1 consists of approximately 45% by weight ground fish, 32% by weight menhaden or herring oil or a combination thereof and 23% by weight palm oil and or palm kernel oil.

4) The bait of claim 1 utilizes a unique binder consisting of palm oil and/or palm kernel oil and that said binder is capable of producing a product that lasts longer in the marine environment than traditional whole or cut fish bait.

5) Method of making the bait which consists of ground herring or menhaden, herring or menhaden oil or a combination thereof and 100% natural palm oil and or palm kernel oil and molding the bait into a form useable in the lobster or crab fishery.
